(19) United States
(12) Patent Application Publication
(10) Pub. No.: US 2014/0100305 A1
(43) Pub. Date: Apr. 10, 2014

(54) MOULDING COMPOSITIONS

(71) Applicant: LANXESS Deutschland GmbH, Cologne (DE)

(72) Inventors: Guenter MARGRAF, Dormagen (DE); Detlev JOACHIMI, Krefeld (DE)

(73) Assignee: LANXESS Deutschland GmbH, Cologne (DE)

(21) Appl. No.: 14/046,293

(22) Filed: Oct. 4, 2013

(30) Foreign Application Priority Data
Oct. 10, 2012 (EP) 12187875.5

(51) Int. Cl. C08L 77/00

(52) U.S. Cl. CPC C08L 77/00
USPC 523/210; 524/514; 524/504

(57) ABSTRACT

This invention relates to polyamide moulding compositions with high resistance to heat/light ageing.

This invention relates to polyamide moulding compositions with high resistance to heat/light ageing, comprising at least one maleic-anhydride-grafted ethylene-butylene copolymer.

### BACKGROUND OF THE INVENTION

When the surface of polyamides is exposed to UV light and atmospheric oxygen, photooxidative reactions occur, with resultant impairment of the appearance, and the mechanical properties, of polyamide-based products. The expression UV light resistance is used when polyamide products are stored in spaces into which UV light penetrates through window glass. The expression weathering resistance is in contrast used when polyamide-based products are stored in the open with exposure to greater variations of moisture levels and of temperature (day/night, rain). The photooxidative processes proceed significantly more rapidly during artificial weathering than during UV irradiation alone (Kunststoff-Handbuch 3/4, Polyamide [Plastics Handbook 3/4, Polyamides], Carl Hanser Verlag, Munich, 1998, pp. 16, 82-84; Nylon Plastics Handbook, Hanser-Verlag, Munich, 1995, pp. 340-342).

The weathering resistance of polyamides can be significantly improved via addition of carbon blacks (Nylon Plastics Handbook, Hanser-Verlag, Munich, 1995, pp. 537-538).

VDA 75202 issued by the Verban der Automobilindustrie e.V. [German Association of the Automotive Industry] describes test methods for determining the colourfastness and the ageing performance of coloured or printed organic materials of every type, and in every processed condition, in respect of exposure to artificial light corresponding to standard illuminant D 65 (daylight) in accordance with DIN 5033-7, but behind window glass, and in respect of simultaneous exposure to heat. The test methods particularly take into account the light/heat conditions occurring in the interior of a motor vehicle.

VDA 75202 discloses the following methods for the determination of colourfastness under exposure condition A (test VDA 75 202-2 A), and also determination of ageing performance under exposure condition A with 4 exposure periods (test VDA 75 202-3 A4):
For determination of colourfastness, under the heading “Method 2”, samples of the material to be tested are exposed to artificial light under defined conditions together with blue lightfastness reference materials made of wool textile. Colourfastness is evaluated by comparing the change in colour of the sample with that of the lightfastness reference materials used. Evaluation by means of grey scale is also possible.
For determination of ageing performance, under the heading “Method 3”, samples of the material to be tested are exposed to artificial light under defined conditions together with lightfastness reference material 6. The change in colour of the sample is evaluated via comparison with the grey scale or with the aid of colour measurement equipment.

In accordance with VDA 752O2. exposure takes place in controlled-temperature and -humidity test chambers made of corrosion-resistant materials, in which the light source is present with filter system and the holders for the test samples. The light source used comprises xenon arc lamps with optical filters.

Blends of polyamides and elastomers exhibit high impact resistance immediately after injection moulding and at low temperatures. Requirements of this are chemical linkage of the elastomer to the polyamide matrix via functional groups, such as carboxylic acid groups, carboxylic ester groups or anhydride groups, and uniform fine-particle distribution of the elastomer. Particular elastomers used are therefore those based on polyolefins, and also on butadiene and acrylate graft rubbers, having carboxylic acid groups, carboxylic ester groups or anhydride groups (Nylon Plastics Handbook, Hanser-Verlag, Munich, 1995, pp. 415-422; Kunststoff-Handbuch 3/4, Polyamide [Plastics Handbook 3/4, Polyamides], Carl Hanser Verlag, Munich, 1998, pp. 16, 133-138).

The use of maleic-anhydride-functionalized ethylene-propylene copolymers for the impact-modification of polyamides is an established method (Nylon Plastics Handbook, Hanser-Verlag, Munich, 1995, pp. 415-419). Maleic-anhydride-functionalized ethylene-propylene copolymers for the impact-modification of polyamide are available commercially, inter alia from ExxonMobil Chemical Europe (Exxelor® VA1801) and Lanxess Deutschland GmbH (Keltan® 2708R).

Other methods that have been described for the impact-modification of polyesters, alongside the use of maleic-anhydride-grafted ethylene-propylene-copolymers, are the use of maleic-anhydride-functionalized ethylene-(1-octene) copolymers for impact-modification (U.S. Pat. No. 5,705,565) and the use of mixtures of ethylene-a-olefin copolymers and maleic-anhydride-functionalized ethylene-a-olefin copolymers (WO99/60062 A1).

The object of the present invention consisted in providing a polyamide moulding composition with, in comparison with the prior art, improved resistance to heat/light ageing.

For the purposes of the present invention, heat/light ageing is ageing in accordance with the VDA 75 202-3 A4 test.

For the purposes of the present invention, resistance to heat/light ageing is determined on test samples aged in accordance with VDA 75 202-3 A4. Prior to and after heat/light ageing (VDA 75 202-3 A4), a colour measurement in accordance with DIN 6167 (standard illuminant D65, standard 10° observer) is carried out on the test samples by using a CM-2600d spectrophotometer from Konica Minolta, and the a,b colour difference ΔE_{ab}* is determined.

The L*a*b* colour space is a colour space which covers the range of visible colours. One of the most important properties of the L*a*b* colour system is that it is independent of equipment, and this means that the definition of the colours is independent of the method used for their generation and of the technology used for their reproduction. EN ISO 11664-4 provides a standard for this colour system.

The L*a*b* colour system is described via a three-dimensional system of coordinates. The a*-axis describes the green or red content of a colour, where negative values represent green and positive values represent red (CIELAB coordinate a*). The b*-axis describes the blue or yellow content of a colour, where negative values represent blue and positive values represent yellow (CIELAB coordinate b*). The L*-axis describes the lightness (CIELAB lightness) of the colour.

The a,b colour difference CIE 1976, ΔE_{ab}* between two perceived colours is calculated as euclidic distance between the points representing the said colours in the colour space:

ΔE_{ab}*=[(ΔL*)²+(Δa*)²+(Δb*)²]^{1/2},

where ΔL* describes the CIELAB lightness difference. Δa* describes the difference between the CIELAB coordinates a* and Δb* describes the difference between the CIELAB coordinates b*. For the purposes of the present invention, a colour measurement in accordance with DIN 6167 (standard illuminant D65, standard 10° observer) was carried out with a CM-2600d spectrophotometer from Konica Minolta on test samples prior to heat/light ageing and after two, and after four, irradiation periods of initiated heat/light ageing (VDA 75 202-3 A4), and in each case the a,b colour difference ΔE_{ab}* was determined after two and, respectively, four irradiation periods of heat/light ageing, and was compared with the initial condition prior to heat/light ageing.

For the purposes of the present invention, high resistance to heat/light ageing means that, in comparison with the prior art cited above, the a,b colour difference ΔE_{ab}* has been reduced by at least 10%, preferably by at least 20%, particularly preferably by at least 30%.

According to the invention, the expression moulding compositions comprises the granulated materials to be used for the injection-moulding process.

### SUMMARY OF THE INVENTION

Surprisingly, it has now been found that moulding compositions comprising the combination of
A) from 38 to 90% by weight, preferably from 45 to 85% by weight, of at least one polyamide with a viscosity number VN of from 130 to 160 ml/g in accordance with DIN EN ISO 307 in sulphuric acid,
B) from 5 to 45% by weight, preferably from 7 to 40% by weight, very particularly preferably from 10 to 20% by weight, of at least one type of glass fibres, and
C) from 5 to 17% by weight, preferably from 8 to 15% by weight, of at least one copolymer based on ethylene and butylene which has been functionalized via reaction with maleic anhydride or with graft copolymers with an unsaturated dicarboxylic anhydride or dicarboxylic acids and/or ester, in particular maleic anhydride, itaconic acid or itaconic anhydride, fumaric acid or maleic acid, where the sum of the percentages by weight of A), B), and C) is always 100, have high resistance to heat/light ageing.

For clarification, it should be noted that the scope of the invention includes any desired combination of any of the definitions and parameters set out hereinafter, in general terms or in preferred ranges. For clarification, it should also be noted that the combination of A). B) and C) makes up from 95 to 99.9% by weight, preferably from 97 to 99.9% by weight, particularly preferably from 98 to 99.9% by weight, of the moulding compositions, and that the remaining amounts of from 0.1 to 5% by weight, preferably from 0.1 to 3% by weight and particularly preferably from 0.1 to 2% by weight, are conventional additives or stabilizers.

### DETAILED DESCRIPTION OF THE INVENTION

The present invention therefore provides moulding compositions comprising the combination of
A) from 38 to 90% by weight, preferably from 45 to 85% by weight, of at least one polyamide with a viscosity number VN of from 130 to 160 ml/g in accordance with DIN EN ISO 307 in sulphuric acid,
B) from 5 to 45% by weight, preferably from 7 to 40% by weight, very particularly preferably from 10 to 20% by weight, of at least one type of glass fibres, and
C) from 5 to 17% by weight, preferably from 8 to 15% by weight, of at least one copolymer based on ethylene and butylene which has been functionalized via reaction with maleic anhydride or with graft copolymers with an unsaturated dicarboxylic anhydride or dicarboxylic acids and/or ester, in particular maleic anhydride, itaconic acid or itaconic anhydride, fumaric acid or maleic acid, where the sum of all of the percentages by weight in the moulding composition is always 100.

In one embodiment, the moulding compositions comprise the combination of
A) from 38 to 90% by weight, preferably from 45 to 85% by weight, of at least one polyamide with a viscosity number VN of from 130 to 160 ml/g in accordance with DIN EN ISO 307 in sulphuric acid,
B) from 5 to 45% by weight, preferably from 7 to 40% by weight, very particularly preferably from 10 to 20% by weight, of at least one type of glass fibres, and
C) from 5 to 17% by weight, preferably from 8 to 15% by weight, of at least one copolymer based on ethylene and butylene which has been functionalized via reaction with maleic anhydride or with graft copolymers with an unsaturated dicarboxylic anhydride or dicarboxylic acids and/or ester, in particular maleic anhydride, itaconic acid or itaconic anhydride, fumaric acid or maleic acid, where the sum of all of the percentages by weight in the moulding composition is always 100, and the combination of A), B) and C) preferably makes up from 95 to 99.9% by weight of the moulding compositions, particularly preferably from 97 to 99.9% by weight, very particularly preferably from 98 to 99.9% by weight.

In preferred embodiments, the moulding compositions comprise, alongside the combination of A), B) and C), from 0.1 to 5% by weight, particularly preferably from 0.1 to 3% by weight, very particularly preferably from 0.1 to 2% by weight, of conventional additives or stabilizers.

In one preferred embodiment of the present invention, the moulding compositions according to the invention also comprise, alongside the combination of components A), B) and C), from 0.1 to 2.0% by weight, particularly preferably from 0.5 to 1.5% by weight, of at least one stabilizer D), where the amounts of one or more of components A), B) and C) are reduced in such a way that the sum of all of the percentages by weight in the moulding composition is always 100.

In another preferred embodiment of the present invention, the moulding compositions according to the invention also comprise, alongside the combination of components A), B), C) and D), or instead of D), from 0.1 to 4% by weight, particularly preferably from 0.2 to 2.0% by weight, of at least one other additive E), where the amounts of one or more of components A), B), C) and/or D) are reduced in such a way that the sum of all of the percentages by weight in the moulding composition is always 100.

There are many known procedures for the production of polyamides, and for different intended final products these use different monomer units, and various chain regulators for adjustment to a desired molecular weight, or else monomers having reactive groups for intended post-treatment processes. The industrially relevant processes for the production of the polyamides to be used in the moulding compositions preferably proceed by way of polycondensation in the melt. According to the invention, the hydrolytic polymerization of lactams is also included as polycondensation here. The production of polyamides via thermal polycondensation is known to the person skilled in the art, see also Nylon Plastics Handbook, Hanser-Verlag, Munich, 1995, pp. 17-27 and Kunststoff-Handbuch 3/4, Polyamide [Plastics Handbook 3/4, Polyamides], Carl Hanser Verlag, Munich, 1998, pp. 22-36.

Polyamides to be used according to the invention are preferably semicrystalline, aliphatic polyamides which can be produced by starting from diamines and dicarboxylic acids and/or from lactams having at least five ring members or from corresponding amino acids, and which have a viscosity number VN of from 130 to 160 ml/g, particularly preferably from 130 to 155 ml/g, very particularly preferably from 140 to 150 ml/g, in accordance with DIN EN ISO 307 in sulphuric acid.

The viscosity number VN is the relative increase, determined under standard conditions, in the viscosity of a solvent due to from 0.1 to 1.0 g/100 ml of dissolved polymer, divided by the concentration in g/100 ml. Standards often used in this connection are DIN 53727, ISO 307, and ASTM D2117, but for the purposes of the present invention the VN has been determined in accordance with ISO 307. According to the invention, the viscosity number VN is formed in commercially available 95% to 98% sulphuric acid via adjustment to 96%. An Ubbelohde viscometer is used in this method to determine the solution viscosity of the polyamide as viscosity number in sulphuric acid.

The person skilled in the art is aware of the use of chain regulators during the polymerization process, and also of solid-phase post-condensation, as methods for the production of polyamides with a defined viscosity number VN or a defined relative viscosity (Kunststoff-Handbuch 3/4, Polyamide [Plastics Handbook 3/4, Polyamides], Carl Hanser Verlag, Munich, 1998, pp. 25-36, 65-73).

Semicrystalline, aliphatic polyamides to be used with preference according to the invention with a viscosity number VN of from 130 to 160 ml/g in accordance with DIN EN ISO 307 in sulphuric acid are preferably obtainable via the process described in DE19801267 A1.

DE19801267 A1 describes adjustment to a defined final viscosity by means of regulation of water content in the melt via appropriate temperature control of the reactor(s), in the range from 0.1 to 0.4% by weight. Polymerization temperatures here are maintained in the range from 230 to 280° C.

DE19801267 A1 discloses a process for the production of granulated polyamide based on nylon-6 (PA 6) with a relative solution viscosity of from 2.2 to 4.8 (1 g of PA 6 in 100 ml of 96% sulphuric acid at 25° C.) via hydrolytic polymerization of caprolactam in the presence of dicarboxylic acids as chain regulator, and then processing of the polymer melt to give granulated material, extraction of the low-molecular-weight fractions from the granulated material with water and then drying of the granulated material, characterized in that fresh lactam is admixed with the extract water which arises during the extraction of the granulated material and which comprises a mixture of caprolactam and oligomers thereof, and then this material is concentrated via evaporation of the water content, and the resultant concentrate is returned to the polymerization process, where the temperature during concentration of the material via evaporation of the extract water does not exceed 120° C., and the concentration of the cyclic dimer after the polymerization process has ended is less than 1% by weight.

Reference may be made to ISO 307 in relation to the conversion of relative viscosity in sulphuric acid to the viscosity number VN.

Starting materials that can be used for the production of the polyamides to be used according to the invention with a viscosity number of from 130 to 160 ml/g are preferably aliphatic and/or aromatic dicarboxylic acids, particularly preferably adipic acid, 2,2,4-trimethyladipic acid, 2,4,4-trimethyladipic acid, azelaic acid, sebacic acid, isophthalic acid, terephthalic acid, aliphatic and/or aromatic diamines, particularly preferably tetramethylenediamine, pentamethylenediamine, hexamethylenediamine, 1,9-nonanediamine, 2,2,4- and 2,4,4-trimethylhexamethylenediamine, the isomers of diaminodicyclohexylmethane, diaminodicyclohexylpropane, bisaminomethylcyclohexane, phenylenediamine, xylylenediamine, aminocarboxylic acids, in particular aminocaproic acid, or the corresponding lactams. Copolyamides of a plurality of the monomers mentioned are included. Preferred chain regulators are monocarboxylic acids, particular preference being given to acetic acid and benzoic acid, and dicarboxylic acids, particular preference being given to terephthalic acid, and monoamines, particular preference being given to benzylamine, and also diamines.

Particular preference is given to nylon-6, nylon-6,6, and to copolyamides comprising caprolactam as comonomer. In particular, preference is given to random, semicrystalline, aliphatic PA 6/66 copolyamides, polymerized from ε-caprolactam and hexamethylenediamine adipate.

ε-Caprolactam (CAS number 105-60-2) is preferably used for the production of polyamide. Cyclohexanone oxime is first produced from cyclohexanone via reaction with the hydrogensulphate or the hydrochloride of hydroxylamine. This is converted into ε-caprolactam via a Beckmann rearrangement. Hexamethylenediamine adipate (CAS number 3323-53-3) is the reaction product of adipic acid and hexamethylenediamine. It is also used inter alia as intermediate in the production of nylon-6,6. The trivial name AH salt derives from the initial letters of the starting substances.

It is, of course, also possible to use mixtures of the polyamides listed, in any desired mixing ratio.

It is moreover possible that fractions of recycled polyamide moulding compositions and/or fibre recyclates are present.

Component B) used comprises from 5 to 45% by weight, particularly preferably from 7 to 40% by weight, very particularly preferably from 10 to 20% by weight, of at least one type of glass fibres. The type of glass fibre to be used according to the invention is preferably selected from the group of the E glass fibres, A glass fibres, C glass fibres, D glass fibres, S glass fibres and/or R glass fibres, particular preference being given in particular to E glass fibres.

The glass fibres to be used according to the invention as component B) preferably have a filament diameter of from 6 to 11 μm, particularly a filament diameter of from 9 to 11 μm. The glass fibres to be used according to the invention preferably have a circular or oval cross-sectional area, particularly preferably a circular cross-sectional area.

In an alternative embodiment, the glass fibres to be used as component B) can have a flat shape and a non-circular cross-sectional area, the major cross-sectional axis of which has a length in the range from 6 to 40 μm, and the minor cross-sectional axis of which has a length in the range from 3 to 20 μm.

In another preferred embodiment, it is possible to use not only circular or oval glass fibres but also non-circular glass fibres alongside one another, as component B).

The form in which the glass fibres to be used as component B) can be added to the moulding composition according to the invention can be that of continuous fibres or that of chopped or ground glass fibres. It is preferable that the glass fibres have been equipped with a suitable size system. Size systems suitable for glass fibres preferably comprise the following components:
coupling agents, particularly preferably based on silane
film-formers
crosslinking agents
lubricants.

It is preferable that these size systems are applied in the form of aqueous polymer dispersions to the glass fibre. It is particularly preferable that these size systems are used as coupling agents for component B) in relation to component A). It is very particularly preferable to use a size system based on silane.

Particular preference is given to coupling agents based on silane of the general formula (I)

(X—(CH₂)_{q})ₖ—Si—(O—CᵣH²ᵣ₊₁)₄₋ₖ (I)

in which

X is NH₂—, HO— or

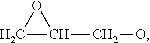

q is an integer from 2 to 10, preferably from 3 to 4,

r is an integer from 1 to 5, preferably from 1 to 2 and

is an integer from 1 to 3, preferably 1.

Very particularly preferred coupling agents are silane compounds from the group of aminopropyltrimethoxysilane, aminobutyltrimethoxysilane, aminopropyltriethoxysilane, aminobutyltriethoxysilane, and also the corresponding silanes which comprise a glycidyl group as substituent X.

The total amount of the dry size composition which is applied as coupling agent to the glass fibre is preferably from 0.05 to 2% by weight, particularly preferably from 0.25 to 1.5% by weight and very particularly preferably from 0.5 to 1% by weight, based on the glass fibre.

Component C) used comprises from 5 to 17% by weight, preferably from 8 to 15% by weight, of at least one copolymer based on ethylene and butylene which has been functionalized via reaction with maleic anhydride or with graft copolymers with an unsaturated dicarboxylic anhydride or dicarboxylic acids and/or ester, in particular maleic anhydride, itaconic acid or itaconic anhydride, fumaric acid or maleic acid. The production of copolymers of this type is described by way of example in U.S. Pat. No. 4,174,358.

Particularly preferred copolymers C) are maleic-anhydride-functionalized copolymers based on ethylene and butylene where the maleic anhydride content of the functionalized copolymers is preferably from 0.1 to 10% by weight, particularly preferably from 0.1 to 5% by weight, very particularly preferably from 0.1 to 2% by weight, based on the entire copolymer, and the repeating units based on the monomers ethylene and butylene are present in the functionalized copolymer in a ratio of the % by weight values of from 4:6 to 3:7.

The density of the functionalized copolymer C) to be used is preferably from 0.80 to 0.95 g/cm³, particularly preferably from 0.85 to 0.90 g/cm³. The density of a material is the quotient calculated from the mass and the volume, and for the purposes of the present invention density is determined in accordance with DIN 53 479.

The volume flow index MVI of the functionalized copolymer C) to be used, measured using 190° C./2.16 kg, is preferably from 1 to 50 cm³/10 min, particularly preferably from 5 to 40 cm³/10 min, very particularly preferably from 10 to 30 cm³/10 min. Reference may be made to B. Carlowitz, Tabellarische Übersicht über die Prüfung von Kunststoffen [Tabular overview of the testing of plastics], 6th Edition, Giesel Verlag für Publizität, 1992 in relation to MVI and its definition and determination. Accordingly, the MVI is the volume of a sample forced through a nozzle under defined conditions within a specified time. This procedure for thermoplastics is carried out in accordance with DIN 53 735 (1988) or ISO 1133-1981. The MVI serves to characterize flow behaviour (test of moulding compositions) of a thermoplastic under specified conditions of pressure and of temperature. It is a measure of the viscosity of a plastics melt.

For the purposes of the present invention. MVI is determined in accordance with ISO 1133 by means of a capillary rheometer, where the material (granulated material or powder) is melted in a heatable cylinder and is forced through a defined nozzle (capillary) under a pressure produced by the applied load. The volume discharged of the polymer melt (known as the extrudate) is determined as a function of time. The unit for the MVI is cm³/10 min.

ISO 1133-1981 describes not only the volume flow index MVI but also the melt index MFI. Reference may be made to B. Carlowitz, Tabellarische Übersicht über die Prüfung von Kunststoffen [Tabular overview of the testing of plastics] 6th Edition, Giesel Verlag für Publizität, 1992 in relation to MFI and its definition and determination. Accordingly, the MFI is the mass of a sample forced through a nozzle under defined conditions within a specified time. The unit for the MFI is g/10 min.

In one preferred embodiment, the functionalized copolymer to be used as component C) can also be used in a mixture with at least one non-functionalized copolymer. The ratio by weight of the functionalized to non-functionalized copolymer can vary within a wide range, but the ratio by weight of functionalized to non-functionalized copolymer is preferably in the range from 1:10 to 10:1; the ratio is particularly preferably smaller than 1, and it is very particularly preferable that the ratio is from 0.9 to 0.1.

For the purposes of the present invention, stabilizers D) are preferably the heat stabilizers described in Plastics Additives Handbook, 5th Edition, Hanser-Verlag, Munich, 2001, pp. 80-84, or the UV stabilizers described in Plastics Additives Handbook, 5th Edition, Hanser-Verlag, Munich, 2001, pp. 352-363.

Preferred heat stabilizers used are copper(I) halides, particularly copper(I) chlorides, copper(I) bromides, copper(I) iodides in conjunction with halides of alkali metals, preferably sodium halides, potassium halides and/or lithium halides, where in turn halides preferably means chloride, bromide or iodide (Kunststoff-Handbuch 3/4, Polyamide [Plastics Handbook 3/4, Polyamides], Carl Hanser Verlag, Munich, 1998, p. 78).

Preference is further given to use of sterically hindered phenols (Kunststoff-Handbuch 3/4, Polyamide [Plastics Handbook 3/4, Polyamides], Carl Hanser Verlag, Munich, 1998, p. 79), hydroquinones, phosphites (Kunststoff-Handbuch 3/4, Polyamide [Plastics Handbook 3/4, Polyamides], Carl Hanser Verlag, Munich, 1998, pp. 79, 82), aromatic secondary amines, in particular diphenylamines (Kunststoff-Handbuch 3/4, Polyamide [Plastics Handbook 3/4, Polyamides], Carl Hanser Verlag, Munich, 1998, p. 79), substituted resorcinols, salicylates, benzotriazoles or benzophenones, and also variously substituted members of these groups or a mixture of these, and also carbon black (Nylon Plastics Handbook, Hanser-Verlag, Munich, 1995, pp. 537-538; Plastics Additives Handbook, 5th Edition, Hanser-Verlag, Munich, 2001, pp. 823, 924-925; Elektrisch leitende Kunststoffe [Electrically Conductive Plastics], Carl Hanser Verlag, Munich, 1989, 2nd Edition, pp. 21-23).

For the purposes of the present invention additives E) are nucleating agents (Plastics Additives Handbook, 5th Edition, Hanser-Verlag, Munich, 2001, pp. 949-959, 966; Plastics Additives Handbook, 5th Edition, Hanser-Verlag, Munich, 2001, pp. 85-88), lubricants and mould-release agents (Plastics Additives Handbook, 5th Edition, Hanser-Verlag, Munich, 2001, pp. 511-541, 546-548), dyes (Plastics Additives Handbook, 5th Edition, Hanser-Verlag, Munich, 2001, pp. 813-818, 872-874), and also additives having branching or chain-extending effect. The additives E) can be used alone or in a mixture, or in the form of masterbatches.

Preferred nucleating agents used are sodium or calcium phenylphosphinate, aluminium oxide, silicon dioxide, and also particularly talc powder.

Preferred lubricants and mould-release agents used are ester waxes, pentaerythritol tetrastearate (PETS), long-chain fatty acids, particularly stearic acid or behenic acid, and esters, salts of these, in particular Ca stearate or Zn stearate, and also amide derivatives, preferably ethylenebisstearylamide, or montan waxes, preferably mixtures of straight-chain, saturated carboxylic acids having chain lengths of from 28 to 32 carbon atoms; other preferred materials used are low-molecular-weight polyethylene waxes and low-molecular-weight polypropylene waxes.

Preferred dyes used are nigrosin dyes. Nigrosin dyes are phenazine dyes having a polycyclic, aromatic structure, and are produced via reaction of nitrobenzene and aniline.

Preferred nigrosin dyes are Solvent Black 7 (CAS 8005-02-5), Solvent Black 5 (CAS No. 11099-03-9) and Acid Black (CAS 8005-03-6).

For the purposes of the present invention, additives having branching or chain-extending effect are preferably epoxidized soya oil (CAS 8013-07-8) and glycidyl ethers, particularly bisphenol A diglycidyl ether.

The polyamide moulding compositions according to the invention are processed via known processes to give the desired products, preferably components, mouldings or semifinished products, preferably via injection moulding.

Injection-moulding processes for thermoplastic polymers for the production of products, components, mouldings or semifinished products operate at melt temperatures in the range from 220 to 330° C., preferably from 230 to 300° C., and also optionally at pressures of at most 2500 bar, preferably at pressures of at most 2000 bar, particularly preferably at pressures of at most 1500 bar and very particularly preferably at pressures of at most 750 bar.

The present invention therefore also provides a process for the production of products, components, mouldings or semifinished products, characterized in that moulding compositions comprising
A) from 38 to 90% by weight, preferably from 45 to 85% by weight, of at least one polyamide with a viscosity number VN of from 125 to 160 in accordance with DIN EN ISO 307 in sulphuric acid,
B) from 5 to 45% by weight, particularly preferably from 7 to 40% by weight, very particularly preferably from 10 to 20% by weight, of at least one type of glass fibres, and
C) from 5 to 17% by weight, preferably from 8 to 15% by weight, of at least one copolymer based on ethylene and butylene, which has been functionalized via reaction with maleic anhydride or with graft copolymers with an unsaturated dicarboxylic anhydride or dicarboxylic acids and/or ester, in particular maleic anhydride, itaconic acid or itaconic anhydride, fumaric acid or maleic acid, where the sum of all of the percentages by weight is always 100, are processed via injection moulding at melt temperatures in the range from 220 to 330° C., and also optionally at pressures of at most 2500 bar.

The process according to the invention provides high resistance to heat/light ageing of polyamide-based products, preferably components, mouldings or semifinished products.

The injection-moulding process is usually carried out by melting (plastifying) the raw material, i.e. the moulding composition according to the invention to be used, preferably in granulated form, in a heated cylindrical cavity and injecting it in the form of injection-moulding composition under pressure into a temperature-controlled cavity. After the composition has cooled (solidified), the injection moulding is demoulded.

A distinction is made between the following individual steps in the injection-moulding process:

1. Plastification/melting

2. Injection phase (charging procedure)

3. Hold-pressure phase (to take account of thermal contraction during crystallization)

4. Demoulding.

An injection-moulding machine to be used for this purpose is composed of a clamping unit, the injection unit, the drive and the control system. The clamping unit has fixed and movable platens for the mould, an end platen, and also tie bars and drive for the movable mould platen (toggle assembly or hydraulic clamping unit).

An injection unit comprises the electrically heatable cylinder, the screw drive (motor, gearbox) and the hydraulic system for displacing the screw and injection unit. The function of the injection unit consists in melting, metering and injecting the powder or the granulated material, and exerting hold pressure thereon (to take account of contraction). The problem of reverse flow of the melt within the screw (leakage flow) is solved via non-return valves.

Within the injection mould, the inflowing melt is then separated and cooled, and the required component or the product or the moulding is thus manufactured. Two mould halves are always necessary for this purpose. A distinction is made between the following functional systems within the injection-moulding process:
Runner system
Shaping inserts
Venting
Machine mounting and force-absorption system
Demoulding system and transmission of motion
Temperature control.

See also Kunststoff-Handbuch 3/4, Polyamide [Plastics Handbook 3/4, Polyamides], Carl Hanser Verlag, Munich, 1998, pp. 315-352 for the injection moulding of polyamides.

The present invention preferably provides the use of copolymers based on ethylene and butylene, which have been functionalized via reaction with maleic anhydride or with graft copolymers with an unsaturated dicarboxylic anhydride or dicarboxylic acids and/or ester, in particular maleic anhydride, itaconic acid or itaconic anhydride, fumaric acid or maleic acid, for the improvement of products, preferably mouldings, components or semifinished products, based on injection-moulded polyamide, in respect of effects caused by heat/light ageing.

The present invention preferably provides the use of copolymers based on ethylene and butylene, which have been functionalized via reaction with maleic anhydride or with graft copolymers with an unsaturated dicarboxylic anhydride or dicarboxylic acids and/or ester, in particular maleic anhydride, itaconic acid or itaconic anhydride, fumaric acid or maleic acid, for the improvement of products, preferably mouldings, components or semifinished products, based on injection-moulded polyamide, in respect of effects caused by heat/light ageing, where the injection-moulding process for production of these uses moulding compositions comprising
A) from 38 to 90% by weight of at least one semicrystalline, aliphatic polyamide with a viscosity number VN of from 125 to 160 ml/g in accordance with DIN EN ISO 307 in sulphuric acid,
B) from 5 to 45% by weight, particularly preferably from 7 to 40% by weight, very particularly preferably from 10 to 20% by weight, of at least one type of glass fibres, and
C) from 5 to 17% by weight, preferably from 8 to 15% by weight, of the copolymer, and the sum of all of the percentages by weight is always 100.

The present invention preferably provides the use of copolymers based on ethylene and butylene, which have been functionalized via reaction with maleic anhydride or with graft copolymers with an unsaturated dicarboxylic anhydride or dicarboxylic acids and/or ester, in particular maleic anhydride, itaconic acid or itaconic anhydride, fumaric acid or maleic acid, for the improvement of products, preferably mouldings, components or semifinished products, based on injection-moulded polyamide, in respect of effects caused by heat/light ageing, where production of these uses moulding compositions comprising
A) from 38 to 90% by weight of at least one semicrystalline, aliphatic polyamide with a viscosity number VN of from 125 to 160 ml/g in accordance with DIN EN ISO 307 in sulphuric acid.
B) from 5 to 45% by weight, particularly preferably from 7 to 40% by weight, very particularly preferably from 10 to 20% by weight, of at least one type of glass fibres, and
C) from 5 to 17% by weight, preferably from 8 to 15% by weight, of the copolymer, and the sum of all of the percentages by weight is always 100, in that
   i) these copolymers are processed via compounding at melt temperatures in the range from 250 to 320° C. in polyamide to give moulding compositions,
   ii) these moulding compositions are processed in the injection-moulding process in injection-moulding machines with use of hot-runner systems at melt temperatures in the range from 250 to 320° C. and at mould temperatures in the range from 40 to 120° C. to give products and
   iii) in the applications of these products they have exposure to UV light.

The expression hot-runner system in connection with compounding is explained in Kunststoff-Handbuch 3/4, Polyamide [Plastics Handbook 3/4, Polyamides], Carl Hanser Verlag, Munich, 1998, p. 325. In accordance with “http://de.wikipedia.org/wiki/Compoundierung”, compounding is a plastics technology term which is equivalent to plastics treatment and describes the process for increasing the value of plastics via admixture of additional substances (fillers, additives, etc.) for the controlled optimization of property profiles. Compounding takes place mainly in extruders, preferably in co-rotating twin-screw extruders, counter-rotating twin-screw extruders, planetary-roll extruders or co-kneaders. Compounding comprises the process operations) conveying, melting, dispersion, mixing, devolatilization and pressurization.

Compounding is intended to change particle size, incorporate additives, and also remove constituents. Many plastics are produced in the form of powders or large-particle resins which cannot be used directly in processing machinery (injection-moulding machines, etc.), and the further processing of these crude compositions is therefore of particular importance. However, materials involved here can be not only raw materials but also in many instances plastics wastes, known as recyclates or regrinds.

The finished mixture made of polymer and of added substances is called moulding composition. The said components of the moulding compositions can take various physical forms:
pulverulent
granular
liquid/flowable.

The intention is to achieve maximum homogeneity of mixing of the components with the moulding composition.

It is preferable that the compounding process uses at least one additive from the group of antioxidants, lubricants, impact modifiers, antistatic agents, carbon fibres, talc powder, barium sulphate, chalk, heat stabilizers, iron powders, light stabilizers, release agents, mould-release aids, nucleating agents, UV absorbers, flame retardants, PTFE, glass fibres, carbon black, glass beads, silicone.

In order to prepare for the compounding procedure, constituents may be removed in advance, preference being given to the removal of moisture content (dehumidification) or the removal of low-molecular-weight constituents (devolatilization).

The mixing of the components takes the form either of what is known as distributive mixing or of what is known as dispersive mixing. Distributive mixing means the uniform distribution of all of the particles in the moulding composition. Dispersive mixing means the distribution and comminution of the components to be incorporated into the mixture. The mixing process can be carried out either in the viscous phase or in the solid phase. In the case of mixing in the solid phase, the distributive effect is important, since the additional substances are already present in comminuted form. Mixing in the solid phase is seldom sufficient to achieve good mixing quality, and the term premixing is therefore often used. The premix is then mixed in the melt.

The viscous mixing process is generally composed of 5 parts.
melting of the polymer and of the additional substances (when possible)
breakdown of the solid agglomerates (agglomerates being clumps)
wetting of the additives with polymer melt)
uniform distribution of the components
removal of undesired constituents (air, moisture, solvents, etc.).

The heat needed in the viscous mixing process is generated mainly via the shear and friction.

In order to improve the absorption and diffusion of the additional material onto the granulated material, the respective plastic, in this case the polyamide, must be mixed at a relatively high temperature. A heating mixer/cooling mixer system is used here. The material is mixed in the heating mixer and then flows into the cooling mixer, where it is temporarily stored. This method is used to produce dry blends. Continuous mixers are mainly used for viscous mixing. Planetary-roll extruders are suitable for the treatment of sensitive materials which require precise temperature control, and also for the processing of very high filler levels (up to 80%).

A particularly effective machine for the mixing process is the co-kneader. This is a single-screw extruder which executes not only a rotary motion but also a translational (forward-and-backward) motion.

The function of an extruder consists in providing the following processes for a plastics composition introduced thereinto: intake, compaction, simultaneous plastification and homogenization with introduction of energy, and conveying under pressure into a profiling die.

The main application sector for a co-rotating twin-screw extruder continues to be plastics compounding. However, the co-rotating twin-screw extruder is also increasingly used for plastics production and processing. The individual steps of plastics compounding are as follows:
compounding and pelletization
incorporating fillers (talc powder, glass fibres, chalk) into plastics
reinforcement of plastics (glass fibres).

Twin-screw extruders with a co-rotating pair of screws are suitable for the compounding of plastics because they provide good mixing. A co-rotating twin-screw extruder has a plurality of individual process zones. There is coupling between these zones, and each zone cannot be considered independently of the others. By way of example, the incorporation of fibres into the melt proceeds not only in the predetermined dispersion zone but also in the metering zone and in other screw-channel sections.

Since most processors require the plastic in the form of pellets, pelletization is of constantly increasing importance. A fundamental distinction is made between hot- and cold-cut, and each of these processes gives different shapes:
beads or lenticular grain shape in the case of hot-cut
cylinders or cubes in the case of cold-cut.

In the case of hot-cut, the extruded strand is chopped directly downstream of the die, by a rotating blade over which water flows. The water here prevents caking of the individual pellets and cools the material. It is preferable to use water for cooling, but it is also possible to use air. The selection of the correct coolant here depends on the material. The disadvantage of water cooling is that the pellets then have to be dried. In the case of cold-cut, the strands are first drawn through a water bath and are then cut in the solid state by a rotary cutter (granulator) to give the desired length.

The products to be produced according to the invention via injection moulding, and improved in comparison with the prior art in their performance in relation to heat/light ageing, preferably mouldings, components or semifinished products, are preferably used in the vehicle industry, particularly in the motor vehicle industry, in particular for the production of window frame cladding for motor vehicles.

The present invention therefore also provides products, preferably mouldings, components or semifinished products, obtainable via use of the moulding compositions according to the invention in the injection-moulding process.

The present invention in particular provides moulding compositions comprising
A) from 38 to 90% by weight, preferably from 45 to 85% by weight, of PA 6/66 copolyamide (polymerized from 95% by weight of c-caprolactam and 5% by weight of hexamethylenediamine adipate) with a viscosity number VN of 146 mVg in accordance with DIN EN ISO 307 in sulphuric acid,
B) from 5 to 45% by weight, particularly preferably from 7 to 40% by weight, very particularly preferably from 10 to 20% by weight, of E glass fibre coated with silane-containing compounds, preferably with a filament diameter of 11 μm, and
C) from 5 to 17% by weight, preferably from 8 to 15% by weight, of ethylene-butylene copolymer comprising 0.7% by weight of grafted maleic anhydride,

where the sum of all of the percentages by weight is always 100.

The present invention further provides the use of ethylene-butylene copolymer, preferably comprising 0.7% by weight of grafted maleic anhydride, for preventing the heat/light ageing of polyamide-based products, preferably polyamide-based products made of moulding compositions comprising
A) from 38 to 90% by weight of PA 6/66 copolyamide—polymerized from 95% by weight of E-caprolactam and 5% by weight of hexamethylenediamine adipate—with a viscosity number VN of 146 ml/g in accordance with DIN EN ISO 307 in sulphuric acid, and
B) from 5 to 45% by weight, particularly preferably from 7 to 40% by weight, very particularly preferably from 10 to 20% by weight, of E glass fibre coated with silane-containing compounds, preferably with a filament diameter of 11 μm, via injection-moulding, where the sum of all of the percentages by weight of copolymer, component A) and component B) in the moulding compositions is always 100.

It is preferable to use from 5 to 17% by weight of the ethylene-butylene copolymer for this purpose, particularly from 8 to 15% by weight, where the sum of all of the percentages by weight in the moulding compositions is always 100.

In one preferred embodiment, the moulding compositions according to the invention also comprise, in addition to components A), B) and C), from 0.1 to 2.0% by weight, particularly from 0.5 to 1.5% by weight, of CuVKBr mixture as heat stabilizer D), where the sum of all of the percentages by weight is always 100, in that the amounts of one or more of components A), B) and/or C) are reduced correspondingly.

In another preferred embodiment, the moulding compositions according to the invention also comprise, in addition to components A), B), C) and D), or instead of D), from 0.1 to 4% by weight, particularly from 0.2 to 2.0% by weight, of at least one additive E), where the sum of all of the percentages by weight is always 100 and talc powder and/or nigrosin is used as additive.

JP 2011 208127 A, JP 2005 298578 A, EP 0 997 496 A1 and CN 101 760 003 A also disclose individual substance combinations which for the purposes of the present invention would equally be suitable for use in moulding compositions intended for providing protection of products to be produced therefrom in respect of heat/light ageing.

It will be understood that the specification and examples are illustrative but not limitative of the present invention and that other embodiments within the spirit and scope of the invention will suggest themselves to those skilled in the art.

### EXAMPLES

In order to demonstrate the improvements described according to the invention in relation to heat/light ageing of injection-moulded products, appropriate polyamide moulding compositions were first manufactured via compounding. The individual components were mixed at temperatures of from 260 to 300° C. in a twin-screw extruder (ZSK 26 Mega Compounder from Coperion Werner & Pfleiderer, Stuttgart, Germany), discharged in the form of strand into a water bath, cooled until pelletizable, and pelletized.

60×60×2 mm test samples of the moulding composition of Inventive Examples 1 and 2 according to the invention, and also of the moulding compositions of Comparative Examples 1 and 2, were injection-moulded in an ARBURG-520 C 200-350 injection-moulding machine at a melt temperature of 260° C. and at a mould temperature of 80° C.

Resistance to heat/light ageing was determined in accordance with VDA 75 202-3 A4 in a Xenotester® Ci 5000 from Atlas Material Testing Technology GmbH, Linsengericht, Germany under the following conditions, which conform to exposure conditions A in VDA 75 202:
1. Xenon arc lamp, water-cooled
2. Boro/SI filter
3. Irradiation intensity: 60 W/m²
4. Specimen compartment temperature: 65° C.
5. Black standard temperature: 100° C.
6. Relative humidity in sample compartment: 30%.

Using reference colour standard 6 on the lightfastness scale in accordance with DIN EN ISO 105-B01, samples of the materials to be tested were secured on a sample holder under the abovementioned conditions, inserted into the Xenotester® Ci 5000, and exposed to heat/light ageing. Lightfastness scales in accordance with DIN EN ISO 105-B01 are composed of a series of reference colour standards using blue dyes on wool textile, sequenced in order of increasing lightfastness and designated by the numerals 1 (low lightfastness) to 8 (very high lightfastness).

Four irradiation periods then followed. For each irradiation period, a new reference colour standard 6 on the lightfastness scale was tested concomitantly. The irradiation was interrupted only for lightfastness scale monitoring.

The end of each irradiation period was reached when the a,b colour difference ΔE_{ab}* achieved was ΔE_{ab}*=4.3+/−0.4 (D65/10°)

(lightfastness scale comparison after heat/light ageing with respect to the initial condition on the lightfastness scale prior to heat/light ageing), and the colour was measured in accordance with DIN 6167 (standard illuminant D65, standard 10° observer), using a spectrophotometer CM-2600d from Konica Minolta.

The 1st irradiation period lasted 84 hours, and the colour difference after this time was ΔE_{ab}*=4.0.

The 2nd irradiation period lasted 84 hours, and the colour difference after this time was ΔE_{ab}*=4.0.

The 3rd irradiation period lasted 84 hours, and the colour difference after this time was ΔE_{ab}*=4.2.

The 4th irradiation period lasted 84 hours, and the colour difference after this time was ΔE_{ab}*=4.1.

A colour measurement in accordance with DIN 6167 (standard illuminant D65, standard 10° observer) was carried out on the test samples prior to heat/light ageing and after two and, respectively, four irradiation periods (VDA 75202-3 A4, Method 3), using a CM-2600d spectrophotometer from Konica Minolta, and in each case the a,b colour difference ΔE_{ab}* was determined after two and, respectively, four irradiation periods in comparison with the initial condition prior to heat/light ageing.

The table below states the amounts of the starting materials in % by weight and the effects according to the invention.

TABLE 1
Inventive examples

| | | Inven- | Inven- | Com- | Com- |
|---|---|---|---|---|---|
| | | tive | tive | par- | par- |
| | | Exam- | Exam- | ison | ison |
| | | ple 1 | ple 2 | 1 | 2 |
| Copolyamide ¹⁾ | [%] | 68.95 | 0 | 68.95 | 0 |
| Nylon-6 ²⁾ | [%] | 0 | 75.46 | 0 | 0 |
| Nylon-6 ³⁾ | [%] | 0 | 0 | 0 | 70.68 |
| Glass fibre ⁴⁾ | [%] | 15 | 15 | 15 | 15 |
| Impact modifier ⁵⁾ | [%] | 15 | 8.5 | 0 | 13 |
| Ethylene-propylene copolymer ⁶⁾ | [%] | 0 | 0 | 15 | 0 |
| Stabilizers ⁷⁾ | [%] | 0.85 | 0.85 | 0.85 | 0.94 |
| Additives ⁸⁾ | [%] | 0.2 | 0.19 | 0.2 | 0.38 |
| Colour measurement, DIN 6167 | | | | | |
| D65 10° prior to heat/light | | | | | |
| ageing: | | | | | |
| L* | | 26.38 | 25.81 | 25.82 | 26.38 |
| a* | | −0.01 | −0.02 | 0.01 | 0.03 |
| b* | | −0.63 | −0.71 | −0.65 | −0.41 |
| Colour measurement in | | | | | |
| accordance with DIN 6187 | | | | | |
| D65 10° after 2 irradiation | | | | | |
| periods of VDA 75202-3A | | | | | |
| heat/light ageing: | | | | | |
| L* | | 26.73 | | 26.35 | 26.97 |
| a* | | −0.02 | | −0.03 | 0 |
| b* | | −0.65 | | −0.75 | −0.55 |
| a, b colour difference | | 0.35 | | 0.54 | 0.60 |
| ΔE_{ab}* after | | | | | |
| 2 irradiation periods in | | | | | |
| comparison with initial | | | | | |
| condition prior to | | | | | |
| heat/light ageing | | | | | |
| Colour measurement in | | | | | |
| accordance with DIN 6167 | | | | | |
| D65 10° after 4 irradiation | | | | | |
| periods of VDA 75202-3A | | | | | |
| heat/light ageing: | | | | | |
| L* | | 26.93 | 26.21 | 26.61 | 27.04 |
| a* | | −0.05 | −0.08 | −0.02 | 0.02 |
| b* | | −0.64 | −0.88 | −0.64 | −0.4 |
| a, b colour difference | | 0.55 | 0.44 | 0.78 | 0.65 |
| ΔE_{ab}* after | | | | | |
| 4 irradiation periods in | | | | | |
| comparison with initial | | | | | |
| condition prior to | | | | | |
| heat/light ageing | | | | | |

¹⁾ PA 6/66 copolyamide with a viscosity number VN of 146 in accordance with DIN EN ISO 307 in sulphuric acid, where the monomer units ε-caprolactam and hexamethylenediamine adipate are present in a ratio of 95% by weight to 5% by weight
²⁾ Nylon-6 with a viscosity number VN of 150 in accordance with DIN EN ISO 307 in sulphuric acid
³⁾ Nylon-6 with a viscosity number VN of 124 in accordance with DIN EN ISO 307 in sulphuric acid
⁴⁾ E glass fibre coated with silane-containing compounds, with a filament diameter of 11 μm
⁵⁾ Ethylene-butylene copolymer comprising 0.7% by weight of grafted maleic anhydride (MVI: 20 cm³/10 min (190° C./2.16 kg), density 0.88 g/cm³), melting point 48° C.
⁶⁾ Ethylene-propylene copolymer comprising 0.7% by weight of grafted maleic anhydride (MVI: 5 cm³/10 min (190° C./2.16 kg), density 0.87 g/cm³)
⁷⁾ Cul/KBr mixture (molar ratio 1:4.5), carbon black
⁸⁾ Mould-release agent.

The moulding compositions of Inventive Examples 1 and 2 exhibit a smaller a,b colour difference ΔE_{ab}* after 2 or 4 irradiation periods of VDA 75202-3A heat/light ageing, and therefore exhibit higher resistance to heat/light ageing, than Comparative Examples 1 and 2.

What is claimed is:

1. A moulding composition comprising the combination of
A) from 38 to 90% by weight of at least one polyamide with a viscosity number VN of from 130 to 160 ml/g in accordance with DIN EN ISO 307 in sulphuric acid,
B) from 5 to 45% by weight, particularly preferably from 7 to 40% by weight, very particularly preferably from 10 to 20% by weight, of at least one type of glass fibres, and
C) from 5 to 17% by weight, preferably from 8 to 15% by weight, of an impact modifier based on copolymers of ethylene and butylene which have been functionalized via reaction with maleic anhydride or with graft copolymers with an unsaturated dicarboxylic anhydride or dicarboxylic acids and/or ester, in particular maleic anhydride, itaconic acid or itaconic anhydride, fumaric acid or maleic acid, where the sum of the percentages by weight of A), B), and C) is always 100.

2. A moulding composition according to claim 1, comprising, alongside components A), B) and C), from 0.1 to 2.0% by weight of at least one stabilizer D), where the amounts of one or more of components A), B) and C) are reduced in such a way that the sum of all of the percentages by weight in the moulding composition is always 100.

3. A moulding composition according to claim 1 or 2, comprising alongside components A), B), C) and D) or instead of D), from 0.1 to 4% by weight of at least one other additive E), where the amounts of one or more of components A), B), C) and/or D) are reduced in such a way that the sum of all of the percentages by weight in the moulding composition is always 100.

4. A moulding composition according to any of claims 1 to 3, wherein the polyamide A) polymerized from ε-caprolactam and hexamethylenediamine adipate is composed of at least 90% by weight of ε-caprolactam.

5. A moulding composition according to any of claims 1 to 4, wherein the maleic anhydride content of the functionalized copolymer C) is from 0.1 to 10% by weight, based on the entire copolymer, and the repeating units based on the monomers ethylene and butylene are present in the functionalized copolymer in a ratio of the % by weight values of from 4:6 to 3:7.

6. A moulding composition according to any of claims 1 to 5, wherein the functionalized copolymer to be used as component C) is used in a mixture with at least one non-functionalized copolymer.

7. A moulding composition according to claim 6, wherein the ratio by weight of functionalized to non-functionalized copolymer is in the range from 1:10 to 10:1.

8. A moulding composition according to any of claims 1 to 7, wherein these comprise the combination of
A) from 38 to 90% by weight of PA 6/66 copolyamide—polymerized from 95% by weight of ε-caprolactam and 5% by weight of hexamethylenediamine adipate—with a viscosity number VN of 146 ml/g in accordance with DIN EN ISO 307 in sulphuric acid,
B) from 5 to 45% by weight of E glass fibre coated with silane-containing compounds and
C) from 5 to 17% by weight of ethylene-butylene copolymer comprising 0.7% by weight of grafted maleic anhydride, where the sum of percentages by weight of A), B) and C) is always 100.

9. A process for the production of products wherein moulding compositions comprising the combination of
A) from 38 to 90% by weight, preferably from 45 to 85% by weight, of at least one polyamide with a viscosity number VN of from 130 to 160 in accordance with DIN EN ISO 307 in sulphuric acid,
B) from 5 to 45% by weight of at least one type of glass fibres, and
C) from 5 to 17% by weight of an impact modifier based on copolymers of ethylene and butylene, which have been functionalized via reaction with maleic anhydride or with graft copolymers with an unsaturated dicarboxylic anhydride or dicarboxylic acids and/or ester, in particular maleic anhydride, itaconic acid or itaconic anhydride, fumaric acid or maleic acid, where the sum of the percentages by weight of A), B), and C) is always 100, are processed via injection moulding at melt temperatures in the range from 220 to 330° C., and also optionally at pressures of at most 2500 bar.

10. A process according to claim 9 wherein the products are components, mouldings or semifinished products.

11. A product, preferably a component, a moulding or a semifinished product, obtainable from moulding compositions according to any of claims 1 to 8.
